(19) United States
(12) Patent Application Publication
(10) Pub. No.: US 2001/0022612 A1
(43) Pub. Date: Sep. 20, 2001

(54) Electronic endoscope apparatus without flicker on screen

(75) Inventors: Mitsuru Higuchi, Omiya-shi (JP); Kazuhiro Yamanaka, Omiya-shi (JP)

Correspondence Address: Ronald R. Snider, Snider & Associates, P.O. Box 27613, Washington, DC, 20036-7613, US

(73) Assignee: Fuji Photo Optical Co., Ltd., Omiya-shi (JP)

(21) Appl. No.: 09/800,910

(22) Filed: Mar. 8, 2001

(30) Foreign Application Priority Data
Mar. 16, 2000 (JP) 2000-74648

(51) Int. Cl. H04N 7/18

(52) U.S. Cl. 348/65

(57) ABSTRACT

In an electronic endoscope apparatus which generates interlaced scanning signals, that is, odd and even field signals, from a video signal obtained by a CCD for display of an image on a TV monitor, there is provided a resolution conversion circuit. For example, the resolution conversion circuit reads twice the same field signal stored in memory at a double speed of a clock signal, writes the signal as a frame signal for non-interlaced scanning, and then twice reads data of the same horizontal line at a quadruple speed of a clock signal. Thereby, a greater resolution image of the same field data can be obtained with 970 horizontal lines arranged with high density in one vertical scanning period. The obtained image is used on a display unit other than a TV monitor.

### BACKGROUND OF THE INVENTION

This application claims the priority of Japanese Patent Application No. 2000-74648 filed on Mar. 16, 2000 which is incorporated herein by reference.

1. Field of the Invention

The present invention relates to an electronic endoscope apparatus, and more specifically to an electronic endoscope apparatus capable of generating and outputting an image signal for display of an image on not only TV monitor, but also other monitors of a personal computer monitor, etc.

2. Description of the Prior Art

Conventionally, an electronic endoscope apparatus for capturing an image inside an object to be observed using CCD (Charge Coupled Device) which is a solid-state image pickup device attached to the tip of an electronic endoscope (electronic scope), and displaying the captured image on a TV monitor has been used. With this apparatus, affected parts of the diseased part can be observed, treated, operated, etc. while seeing the object to be observed.

### BRIEF SUMMARY OF THE INVENTION

Object of the Invention

Recently, it has been suggested that an image obtained by an electronic scope is displayed on a monitor other than a TV monitor, such as a personal computer monitor, etc. (computer display). Thus, the obtained image has been effectively used in storing the record of the object to be observed and checking it later, etc.

However, an image signal to be displayed on a TV monitor is an interlaced scanning signal, and a 1-frame image is displayed with the image signals of odd and even fields together, thereby easily causing flicker of the screen. Since the number of scanning lines can be freely set on a personal computer monitor, the quality of an image can be improved if it can be utilized to provide greater resolution.

The present invention has been achieved to solve the above mentioned problems, and aims at providing an electronic endoscope apparatus capable of reducing flicker on the screen when an image obtained by an endoscope is displayed on a display unit, etc. other than a TV monitor, thereby improving the quality of the image by providing greater resolution.

### SUMMARY OF THE INVENTION

To attain the above mentioned purpose, the present invention includes a circuit for generating an interlaced scanning signal for display of an image on a TV monitor from an image signal obtained by an image pickup device, and a progressive resolution conversion circuit for generating a non-interlaced scanning signal with higher vertical resolution than a frame signal for a TV monitor by reading and overlapping the same field signals for the above mentioned interlaced scanning.

With the above mentioned configuration, for example, odd field data (horizontal line data) temporarily stored in the memory of the resolution conversion circuit for the interlaced scanning can be read twice at a double speed of a writing speed, and stored as a frame signal in frame memory. Then, the same odd field data is twice read at, for example, a further double speed from the frame memory. A similar process is performed on the even field data. Thus, in the vertical scanning period in which the above mentioned field signal is obtained, a frame signal for the non-interlaced scanning is generated with horizontal lines of the same data of an odd or even field continuously arranged four times.

Therefore, when an image is displayed on a monitor of a personal computer, etc. using an image signal for the interlaced scanning, it can be provided with greater vertical resolution with horizontal lined tightly arranged. Furthermore, since the same odd field data can form one frame, a blurry image often obtained when there is a movement among the fields can be successfully avoided. Furthermore, the number of times the same horizontal line is read from the frame memory can be n (n is an integer) equal to or larger than 3. In this case, it is desired that the reading speed can be correspondingly higher (n times).

### BRIEF DESCRIPTION OF THE DRAWINGS

FIG. 1 is a block diagram of a configuration of an electronic endoscope apparatus according to an embodiment of the present invention;

FIG. 2 is a block diagram of a configuration of are solution conversion circuit shown in FIG. 1;

FIG. 3 is a block diagram of another configuration of the resolution conversion circuit shown in FIG. 1;

FIGS. 4A to 4C show conversion of a signal in the resolution conversion circuit according to an embodiment the present invention;

FIGS. 5A to 5F are timing charts showing a signal process in the resolution conversion circuit according to an embodiment of the present invention;

FIGS. 6A to 6D are timing charts showing the signal process performed in a pixel unit in the resolution conversion circuit according to an embodiment of the present invention; and

FIGS. 7A to 7B are timing charts showing the signal process performed in a horizontal line unit in the resolution conversion circuit according to an embodiment of the present invention.

### DETAILED DESCRIPTION OF THE PREFERRED EMBODIMENTS

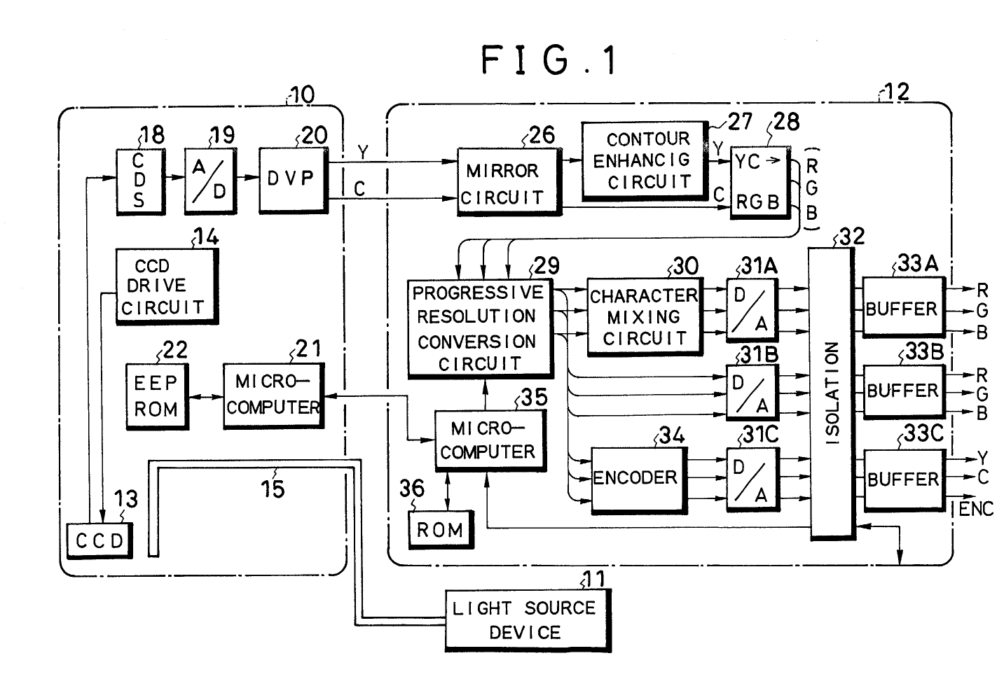

FIG. 1 shows a configuration of an electronic endoscope apparatus according to an embodiment of the present invention. This apparatus is designed by connecting an electronic endoscope (electronic scope) 10 to a light source device 11 and a processor device 12. First, the electronic scope 10 comprises a CCD 13 at the tip of the scope corresponding to the number of scanning lines in the NTSC system through an optical objective system. A CCD drive circuit 14 is provided to drive the CCD 13, and a light guide 15 is provided to emit a light from the tip. The light guide 15 is set for a light source and a stop for the quantity of light, and is then connected to the light source device 11.

The CCD 13 is provided with a correlated double sampling circuit (CDS) 18, an A/D (analog/digital) converter 19, and a digital video processor (DVP) 20. The DVP 20 generates a luminance signal (Y) and a color difference signal (C) in a digital process performed on an image signal (video signal) output from the CCD 13, and performs an image process such as amplification, white balance, gamma amendment, etc.

In addition, a microcomputer 21 for performing an integral control on each circuit is provided, and ROM (read-only memory, for example, EEPROM) 22 for storing process information (or ID information) in the electronic scope 10 is provided.

On the other hand, the processor device 12 comprises a mirror circuit 26 for inverting left and right of an image, a contour enhancing circuit (enhancer) 27, a color conversion circuit 28 for converting a luminance signal (Y) and a color difference signal (C) into a signal of R (red) G (green), and B (blue), a progressive resolution conversion circuit 29 (described later in detail) for generating a non-interlaced scanning signal (progressive signal), and converting the resolution corresponding to the monitor of a personal computer, etc., a character mixing circuit 30 for mixing characters of patient information, pickup data, etc., and a D/A converter 31A. An analog/video signal output from the D/A converter 31A is provided for a personal computer monitor, etc. through an isolation 32 and a buffer circuit 33A.

According the apparatus, an image can be output not only to the above mentioned personal computer monitor, but also to a TV monitor and an RGB monitor. At the subsequent stage of the progressive resolution conversion circuit 29, a D/A converter 31B and a buffer circuit 33B are provided for a RGB monitor, and an encoder 34 for converting an RGB signal into a Y signal and a C signal, a D/A converter 31C, and a buffer circuit 33C are provided for a TV monitor. Each of these units are provided with an image output terminal. An output video signal for the TV monitor and the RGB monitor is not resolution-converted by the progressive resolution conversion circuit 29.

Furthermore, a microcomputer 35 for integrally controlling each circuit in the processor device 12 and ROM 36 are provided. The ROM 36 stores the process information (or ID information) obtained by the processor device 12. When the above mentioned electronic scope 10 is connected to the processor device 12, information is communicated between the microcomputer 21 at the side of the electronic scope 10 and the above mentioned microcomputer 35, each of the microcomputers 21 and 35 controls each circuit such that the optimum image process can be performed.

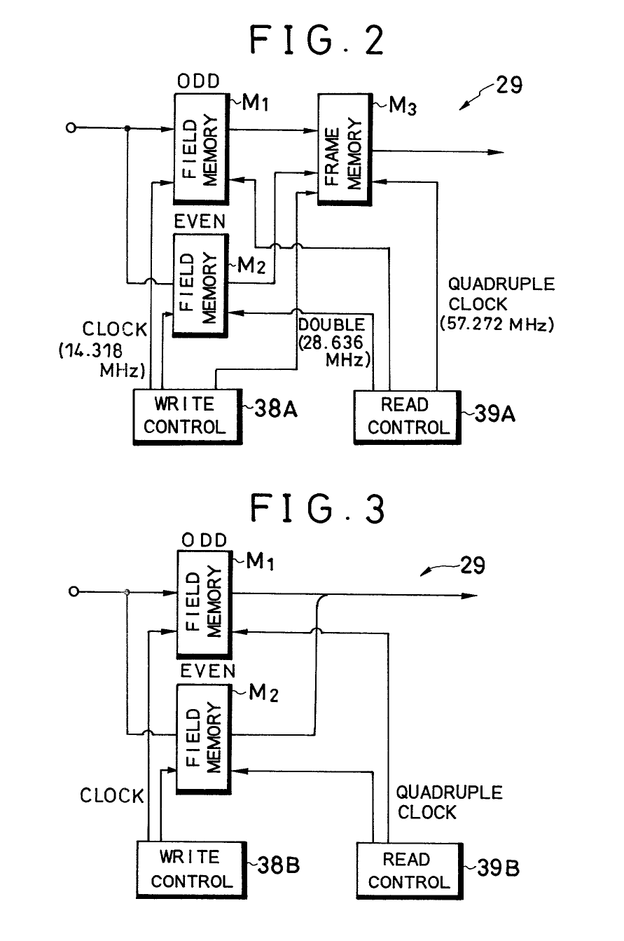

FIGS. 2 and 3 shows two examples of the configurations in the progressive resolution conversion circuit 29. In the examples, it is assumed that the circuit shown in FIG. 2 is adopted. As shown in FIG. 2, the progressive resolution conversion circuit 29 comprises two field memory M₁ and M₂, frame memory M₃, a write control circuit 38A, and a read control circuit 39A. The write control circuit 38A writes data at the clock frequency of 14.318 MHz (a horizontal scanning signal refers to a clock speed of a frequency of 15.734 kHz, and is equivalent to driving the CCD 13 in the NTSC system) corresponding to 1 pixel for the above mentioned field memory M₁ and M₂, and writes data at a double clock speed of a frequency of 28.636 MHz (a horizontal scanning signal refers to a frequency of 31.468 kHz) for the above mentioned frame memory M₃.

The read control circuit 39A reads data at a double speed of a frequency of 28.636 MHz for the block diagram field memory M₁ and M₂, and reads data at a quadruple speed of 57.272 MHz (a horizontal scanning signal refers to 62.936 kHz) for the above mentioned frame memory M₃.

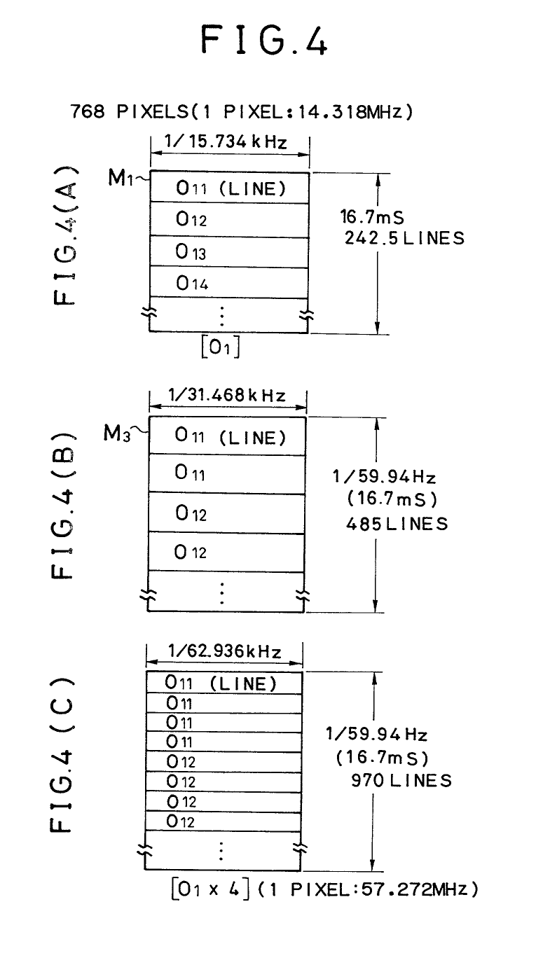

FIGS. 4A to 4B show the conversion of a signal by the progressive resolution conversion circuit 29. As shown in FIG. 4A, 242.5 horizontal line data O₁₁, O₁₂, O₁₃, . . . (odd fields) formed by 768 pixels in the horizontal direction and output from the CCD 13 is written to the field memory M₁, and horizontal line data E₁₁, E₁₂, E₁₃, . . . (even fields which refer to interlaced scanning signals) is similarly written to the memory M₂ at a speed of 15.734 kHz. Then, the odd field data in the memory M₁ is read at a double speed of 31.468 kHz, and, as shown in FIG. 4B, written twice to the frame memory M₃ at the same speed. In this example, 1-frame data of 485 lines (a progressive signal for non-interlaced scanning) is written at a double clock speed, and the vertical scanning period is 1/59.94 Hz≈16.7 ms as in the case shown in FIG. 4A. The even field data in the memory M₂ is also written twice, thereby converting the data into a progressive signal.

Then, as shown in FIG. 4C, the data in the above mentioned frame memory M₃ is read twice at a double speed, that is, 62.936 kHz (a quadruple clockspeed). Then, in the vertical scanning period of about 16.7 ms (1/59.94 Hz), four same horizontal lines are vertically arranged. That is, a total of 970 lined are arranged, thereby displaying an image on a personal computer monitor, etc. as quadruple amount of data of the same odd or even field compressed into ¼ in the horizontal direction.

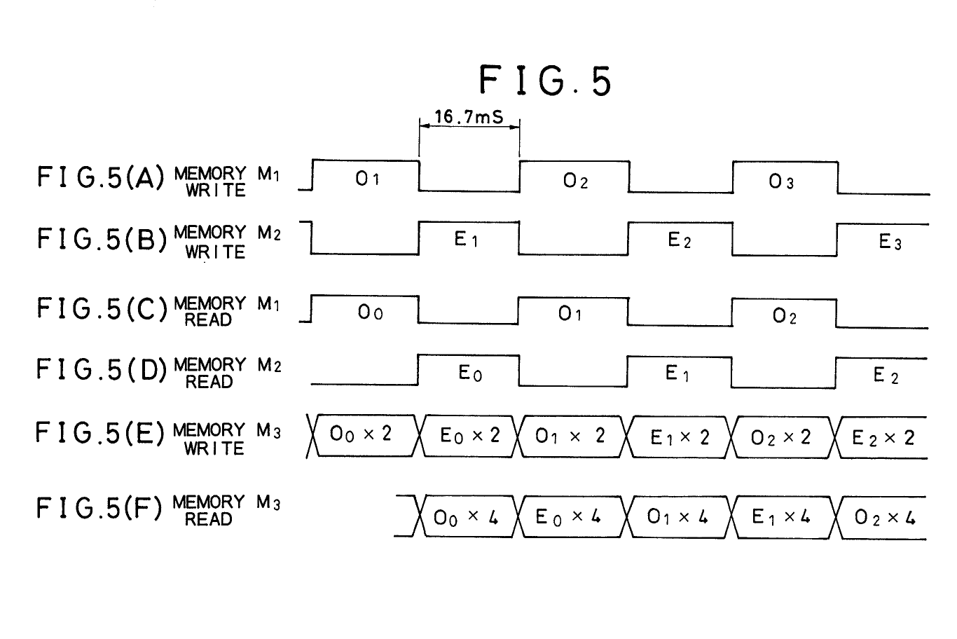

The present embodiment has the above mentioned configuration, the effect of which is described below by referring to FIGS. 5 through 7. First, the CCD 13 in the electronic scope 10 shown in FIG. 1 forms a video signal from an object to be observed alternately as an odd field signal or an even field signal. The video signal is read by a clock signal (a horizontal scanning speed of 15.734 kHz) of 14.318 MHz, and various image processes are performed on it as a digital signal by the DVP 20 after the CDS 18. The Y and C signals are output from the DVP 20. These signals are provided for the contour enhancing circuit 27 from the mirror circuit 26 in the processor device 12, and the left-right inverting process and the contour enhancing process are performed on the signals. The Y and C signals are converted into RGB signals by the color conversion circuit 28, and then provided for the progressive resolution conversion circuit 29.

In this progressive resolution conversion circuit 29, the data of the odd fields O₀, O₁, O₂, . . . and the data of the even fields E₀, E₁, E₂, . . . are respectively written to the memory M₁ and memory M₂ alternately as shown in FIGS. 5A and 5B. The data in the memory M₁ and M₂ is read in the subsequent vertical scanning period as shown in FIGS. 5C and 5D. The horizontal line data of the fields is read at a double clock speed, and a progressive signal overlapping twice for the same line is written to the memory M₃ as indicated by O₀×2, E₀×2, O₁×2, . . . shown in FIG. 5E (FIG. 4B).

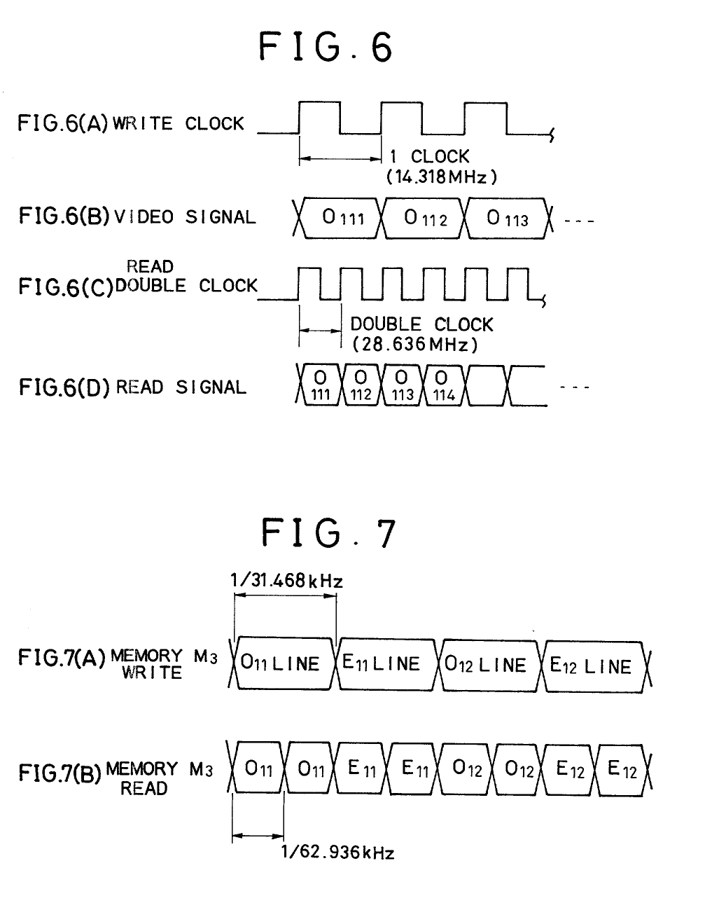

FIGS. 6A to 6D show the writing and reading processes in the memory M₁ in pixel unit. The write clock in a pixel unit shown in FIG. 6A refers to a frequency of 14.318 MHz. In this clock unit, the pixel signals O₁₁₁, O₁₁₂, O₁₁₃, . . . (odd fields) shown in FIG. 6B are read. For the read signals, the double clock of a frequency of 28.636 MHz shown in FIG. 6C is used, thereby twice reading the signals O₁₁₁, O₁₁₂, O₁₁₃ shown in FIG. 6D.

Then, the data stored in the M₃ is read in the subsequent vertical scanning period ad shown in FIG. 5F. The reading process is performed twice at a quadruple clock speed as shown in FIGS. 7A and 7B. FIGS. 7A and 7B show the signal process in a horizontal line unit in a process of reading data at a double speed. As shown in FIG. 7A, a process of writing the horizontal line data O₁₁, O₁₁, O₁₂, O₁₂, . . . to the memory M₃ is performed at a speed (double clock) of 31.468 KHz. The process of reading data from the memory M₃ is performed twice at a speed of a frequency of 62.936 kHz (quadruple clock) as shown in FIG. 7B.

Therefore, as shown in FIG. 4C or 5F, the 970 horizontal lines of the same field are sequentially arranged, for example, O₁₁, O₁₁, O₁₁, O₁₁, O₁₂, O₁₂, . . . etc. in one vertical scanning period. Thus, the data of the same field can form one non-interlaced screen, thereby obtaining an excellent image of even a movable object to be observed. That is, since an odd field signal and an even field signal obtained every 16.7 ms are overlapped in the interlaced scanning process, a blurry image is output when an object to be observed or the tip of the scope moves in the period of 16.7 ms. However, according to the present invention, one screen is formed by the signals of the same odd or even fields, thereby removing the above mentioned blurry image.

In FIG. 1, the video signal is output after the conversion of resolution as an analog signal from the buffer circuit 33A to a personal computer monitor, etc. after mixing the character signals in the character mixing circuit 30. Since a displaying process is performed on an input video signal by a horizontal fly-back line signal and a vertical fly-back line signal in this personal computer, high-density data of 970 horizontal lines is compressed and displayed on one screen, thereby obtaining an image of greater resolution. Furthermore, since the number of lines doubles while the data is compressed into ½ in the vertical direction, the image does not deform in the vertical direction.

Additionally, since a video signal which is not resolution-converted is output from the progressive resolution conversion circuit 29 to the D/A converter 31B and the encoder 34, an RGB video signal can be output to the RGB monitor through the buffer circuit 33B. On the other hand, the encoder 34 can re-convert the signal into the Y signal and the C signal, and provide them for a TV monitor through the buffer circuit 33C, thereby displaying an image of an object to be observed on the TV monitor.

FIG. 3 shows another example of the configuration of the progressive resolution conversion circuit 29. In this case, the circuit comprises two memory M₁ and M₂, a write control circuit 38B, and a read control circuit 39B. Then, the write control circuit 38B writes field data at a clock speed of 14.318 MHz to the memory M₁ and M₂. Data is read four times for the same horizontal line from the memory M₁ and M₂ at a quadruple speed of 57.272 MHz. Thus, as shown in FIG. 4C, an image can be displayed with the data of 970 horizontal lines arranged with high density in 16.7 ms vertical scanning period.

In the above mentioned example, the NTSC system is adopted. It is also possible to form a non-interlaced scanning signal in the PAL system by using a CCD corresponding to the PAL (phase alternation by line) system, and by using a resolution conversion circuit in the PAL system regarding to the above-mentioned resolution conversion circuit.

As described above, according to an embodiment of the present invention, a high-quality image can be displayed with greater resolution when the image is displayed in a display unit other than a TV monitor. Furthermore, the image can be displayed without any flicker, and a blurry image can be avoided especially when there is a movement between fields.

What is claimed is:

1. An electronic endoscope apparatus which removes flicker on a screen, comprising:
a circuit for generating an interlaced scanning signal for display of an image on a TV monitor from an image signal obtained by an image pickup device; and
a progressive resolution conversion circuit for generating a non-interlaced scanning signal with higher vertical resolution than a frame signal for a TV monitor by reading and overlapping same field signals for interlaced scanning.

2. The electronic endoscope apparatus which removes flicker on a screen according to claim 1, wherein
said progressive resolution conversion circuit can generate a non-interlaced scanning signal for one frame by reading one field signal three times or more.

3. The electronic endoscope apparatus which removes flicker on a screen according to claim 1, further comprising:
a field memory for storing a field signal for interlaced scanning;
a frame memory for storing a frame signal for non-interlaced scanning; and
a write/read control circuit for reading twice a field signal in said field memory at a double speed of a write speed for the signal, temporarily writing the signal in said frame memory, and controlling the frame signal in said frame memory such that the frame signal can be read twice at a double speed of a write speed of the frame signal.

4. The electronic endoscope apparatus which removes flicker on a screen according to claim 1, further comprising:
a field memory for storing a field signal for interlaced scanning; and
a write/read control circuit for controlling the field signal in said field memory such that the signal can be read n times at a speed n (integer) times as fast as a write speed for the signal.
